(19) United States
(12) Patent Application Publication
(10) Pub. No.: US 2017/0046117 A1
(43) Pub. Date: Feb. 16, 2017

(54) ACOUSTIC APPARATUS WITH SHARED CLOCK

(71) Applicant: Knowles Electronics, LLC, Itasca, IL (US)

(72) Inventors: Ramanujapuram Raghuvir, Oak Brook, IL (US); Robert Popper, Lemont, IL (US); Dibyendu Nandy, Naperville, IL (US); Oddy Khamharn, Lombard, IL (US)

(73) Assignee: Knowles Electronics, LLC, Itasca, IL (US)

(21) Appl. No.: 15/232,735

(22) Filed: Aug. 9, 2016

Related U.S. Application Data
(60) Provisional application No. 62/203,078, filed on Aug. 10, 2015.

(51) Int. Cl. G06F 3/16; H04R 3/00

(52) U.S. Cl. CPC G06F 3/162; H04R 3/005

(57) ABSTRACT

An acoustic apparatus includes a first digital microphone having a first clock pin, a second digital microphone having a second clock pin, an application processor having a third clock pin, a first interface that couples the first digital microphone and the application processor, and a second interface that couples the first digital microphone, the second digital microphone, and the application processor. The acoustic apparatus further includes a clock that connects to the first clock pin, the second clock pin, and the third clock pin, wherein first data is transmitted on a first clock edge, and wherein second, different data is transmitted on a second other clock edge.

### CROSS-REFERENCE TO RELATED APPLICATIONS

This application claims the benefit of and priority to U.S. Provisional Patent Application No. 62/203,078, filed Aug. 10, 2015, the entire contents of which are incorporated herein by reference.

### TECHNICAL FIELD

This application relates to microphones and, more specifically, to the interaction of elements within these microphone systems.

### BACKGROUND

Different types of acoustic devices have been used through the years. One type of device is a microphone assembly. A microphone assembly may be a “smart microphone” that includes a transducer element (that picks up sounds), buffers, and processing units (e.g., digital signal processors performing conversion and/or non-conversion functions). A microphone assembly may also be a “standard digital microphone” in which only conversion functions are performed by a transducer.

One type of transducer is a microelectromechanical system (MEMS) device that includes a diagram and a back plate. The MEMS device is supported by a substrate and enclosed by a housing (e.g., a cup or cover with walls). A port may extend through the substrate (for a bottom port device) or through the top of the housing (for a top port device). In any case, sound energy traverses through the port, moves the diaphragm and creates a changing potential of the back plate, which creates an electrical signal. Microphones assemblies are deployed in various types of devices such as personal computers or cellular phones.

Interfaces are used between the microphone assemblies and external processing components. For example, PDM and I2S interfaces are used between hardware components. Interfaces are typically standardized so that devices produced by one user may be utilized or operated in a variety of settings and applications.

The interfaces are typically defined by the communication lines between components and each line requires a separate pin on the microphones. For instance, PDM interfaces require three pins to be present on the microphone, while the I2S standard interfaces require four pins for normal operation.

Some situations and applications require the microphone be able to support both PDM and I2S interfaces simultaneously. However, this has proved impossible to accomplish with only four pins. Due to package size restrictions for the microphone, the number of pins cannot be typically increased beyond four pins.

The problems of previous approaches have resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a block diagram of a system with a codec supplying a shared clock according to various embodiments of the present invention;

FIG. 2A comprises a block diagram of a system with an application processor supplying a shared clock according to various embodiments of the present invention;

FIG. 2B comprises a block diagram of a system with a smart microphone supplying a shared clock according to various embodiments of the present invention;

FIG. 3 comprises a block diagram of a system with a codec supplying a shared clock according to various embodiments of the present invention;

FIG. 4A comprises a block diagram of a system with an application processor supplying a shared clock according to various embodiments of the present invention;

FIG. 4B comprises a block diagram of a system with a smart microphone supplying a shared clock according to various embodiments of the present invention;

FIG. 5 comprises a block diagram of a system with a codec supplying a shared clock according to various embodiments of the present invention;

FIG. 6A comprises a block diagram of a system with an application processor supplying a shared clock according to various embodiments of the present invention;

FIG. 6B comprises a block diagram of a system with a smart microphone supplying a shared clock according to various embodiments of the present invention;

FIG. 7 comprises a block diagram of a system with a codec supplying a shared clock according to various embodiments of the present invention;

FIG. 8A comprises a block diagram of a system with an application processor supplying a shared clock according to various embodiments of the present invention;

FIG. 8B comprises a block diagram of a system with a smart microphone supplying a shared clock according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The present approaches provide for a shared clock between different interfaces in a microphone assembly (e.g., sharing the clock between the PDM and I2S interfaces). A word strobe (WS) signal can also be generated from the shared clock. The shared clock may originate in a wide variety of components (e.g., smart microphone, codec, or application processor). In so doing, simultaneous use of the two interfaces (e.g., PDM and I2S) to exchange data is supported with a minimal number of pins on the microphone assemblies. Consequently, the microphone assemblies can be maintained in an adequate size since each additional pin required substantially increases the size of the microphone assembly.

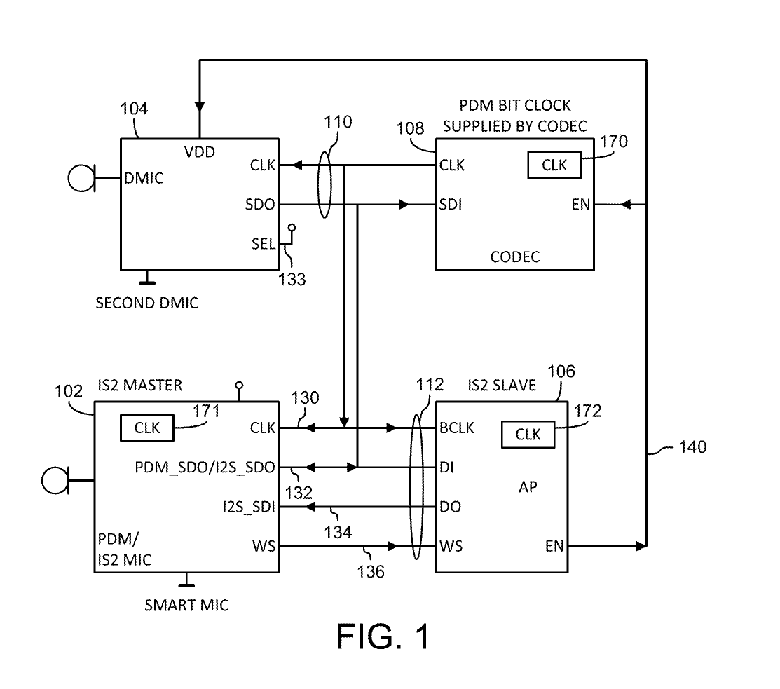

Referring now to FIG. 1, a system 100 includes a smart microphone (Smart Mic) 102, a standard digital microphone (DMIC) 104, an application processor (AP) 106, and a codec 108.

A pulse density modulation (PDM) interface (or PDM-compliant interface) 110 couples DMIC 104, codec 108, and Smart Mic 102. While the application processor (AP) 106 is connected to the PDM interface, data on the PDM line may be ignored. The PDM interface 110 includes a clock line 130, a data line 132, and a select line 133.

Each of the lines of the PDM interface 110 has a corresponding pin on DMIC 104 (a clock (CLK) pin, a serial data out (SDO) pin, and a select pin). Stereo channel communication is possible (left and right channels). The select pin is an input to the DMIC 104 and can be sit high or low. This allows data to be selected on the rising edge or the falling edge of the clock (left and right channels depending upon whether set high or low). In this case, the select pin is set to a fixed value (high or low) so that the DMIC 104 transmits PDM data on one of the clock edges but not the other edge. The Smart Mic 102 can be programmed to transmit data on the other edge, and hence does not require a select pin.

An I2S interface 112 couples the Smart Mic 102 and the application processor 106. The I2S interface includes the clock line 130 (which is shared with the PDM interface), the data line 132 (which is shared with the PDM interface 112), a data line 134, and word strobe (WS) line 136. The word strobe line 136 carries a pulsed signal (strobe) by which the word boundaries of the data that is clocked is defined.

The I2S interface is compliant with the I2S standard and each line has a corresponding pin on the Smart Mic 102 and AP 106 (a word strobe (WS) pin, a data out (DO) pin, a Data in (DI) pin, and a clock (CLK) pin). Bi-directional stereo channel communication is possible. WS sets the channel boundary (for left and right channels).

In summary, each of the four separate hardware components (Smart Mic 102, DMIC 104, AP 106, and codec 108) has pins that connect to the appropriate communication line. More specifically, the DMIC 104 has a pin (CLK) connected to the clock line 130; a pin (SDO) connected to data line 132; and a pin (SEL) connected to the select input. The codec 108 has a pin (CLK) connected to the clock line 130; and a pin (SDI) connected to data line 132. The Smart Mic 102 has a pin (CLK) connected to the clock line 130; a pin (PDM_SDO/I2S_SDO) connected to data line 132; a pin I2S_SDI connected to data line 134; and a pin (WS) connected to the word strobe line 136. The AP 106 has a pin (BCLK) connected to the clock line 130; a pin (DI) connected to data line 132; a pin (DO) connected to data line 134; and a pin (WS) connected to the word strobe line 136. As will be appreciated, the I2S interface 112 includes four pins while the PDM interface 110 requires three pins. No additional pins are required because the clock is shared between interfaces and between devices.

The codec 108 has an internal clock 170. The Smart Mic 102 has an internal clock 171. The AP 106 has an internal clock 172.

The smart microphone (Smart Mic) 102 converts sound energy into a digital signal, but unlike the DMIC 104, provides additional functions besides conversion. In this example, the Smart Mic 102 has a processor that performs additional digital signal processing functions. Other examples are possible. When it is an I2S master, the Smart Mic 102 receives a clock signal (from the internal clock 170 of the codec 108) to which it synchronizes its WS signal which is transmitted on the WS line 136. As mentioned, the Smart Mic 102 has an internal clock 171 (not received from an outside source) by which it operates until the outside clock (clock 170 via line 130) is received.

The standard digital microphone (DMIC) 104 receives and converts sound energy into a PDM signal. In these regards, the DMIC 104 may include a transducer (e.g., a MEMS transducer with a diaphragm and back plate) and a sigma delta converter (or other analog to digital converter). The DMIC 104 does not include any processing units or intelligence.

The application processor (AP) 106 may be connected to other parts of a system including displays, global positioning satellite (GPS) processing, location determination, or navigation units, and other non-audio electronic elements. The AP 106 may include processing functionality, but acts as a gateway between the audio components (e.g., the DMIC 104 and Smart Mic 102) and non-audio electronic elements. The AP 106 enables or disables the codec 108 with an enable (EN) line 140. As mentioned, the AP 106 includes an internal clock 172 (not from an external source) and may use this clock 172 to operate in the absence of the clock 170 over line 130. When AP 106 is the master (as between the AP 106 and Smart Mic 102), it may generate a WS signal that is output on the WS signal 136. By “word strobe” signal and as used herein, it is meant a signal pulse that defines the boundaries of a group of data (e.g., a word of data).

The codec 108 takes digital signals and processes these signals using a processor. Alternate data paths may exist between the codec 108 and the AP 106. The codec 108 does not pick up or detect sound. The codec 108 is enabled or disabled by the enable line (EN) 140 from the AP 106. As mentioned, the codec 108 has its internal clock 170 that is used as a shared clock by the Smart Mic 102 and the DMIC 104, and as the clocking signal in both the PDM interface 110 and the I2S interface 112.

By “internal” clock and as used herein, the clock is disposed in the physical module (i.e., on the separate piece of silicon) that forms the codec 108. By “external” clock, it is meant a clock that is not physically within or on the codec assembly or piece of silicon (when the codec is an integrated circuit). It will be appreciated that the various components (Smart Mic 102, codec 108, and AP 106) may all have internal clocks that may be utilized before receiving an external clock. For instance and in the example of FIG. 1, the AP 106 and the Smart Mic 102 may utilize their internal clocks before receiving the external clock supplied by the codec 108.

In the following description, it will also be appreciated that certain devices act as a “master” while other devices act as a “slave.” By “master,” it is meant that this device controls and directs traffic across an interface, while a “slave” device merely reacts to commands or other data sent by the master device.

In one example, of the operation of the system of FIG. 1, the codec 108 is enabled (via enable line 140) and the Smart Mic 102 is the master (as between the AP 106 and the Smart Mic 102). The AP 106 turns EN line 140 on (or sends an enable bit). This action turns the codec 108 on to produce the clock signal 130, which is sent to the Smart Mic 102 and the AP 106. This action also activates the DMIC 104.

Smart Mic 102 and the DMIC 104 convert sound energy into digital signals. One of these devices sends out data to the codec 108 on the rising edge of the codec clock 130 and the other on the falling edge of the codec clock 130 via data line 132.

The clock signal 130 (originating as the internal clock 170 of the codec 108) goes untouched and unaltered to the AP 106. The smart microphone 102 synchronizes its word strobe (WS) signal 136 with the codec clock 170 transmitted over line 130. In these regards, the smart microphone 102 may count clock pulses of the received codec clock 170 transmitted over line 130 up to a number (e.g., 32) and then toggle WS 136, and then may continue to repeat this process.

The AP 106 may send I2S data to the smart microphone 102 via data line 134. The standard digital microphone 104 may send data to the codec 108 on one edge of the clock 170 transmitted over line 130.

The smart microphone 102 is capable of simultaneous transmission of PDM data (to the codec 108 over the PDM interface) and reception of I2S data (from the AP 106).

In another example of the operation of the system of FIG. 1, the codec 108 is disabled and the smart microphone 102 is the master (as between the AP 106 and the Smart Mic 102). The AP 106 disables the codec 108 and the DMIC 104. In other words, the smart microphone 102 is the master and AP 106 is the slave. In this example, the internal clock 171 of the smart microphone 102 is used by the AP 106. WS 136 is synchronized with internal clock 171 of smart microphone 102. Bi-directional exchange of I2S data (between smart microphone and AP) is possible by disabling the PDM interface (i.e., by disabling the codec 108 and the DMIC 104).

In still another example of the operation of the system of FIG. 1, the codec 108 is disabled, and the AP 106 is the master (as between the AP 106 and the Smart Mic 102). In this case, the direction of the arrows for 130 and 136 would be reversed.

The AP 106 disables the codec 108 and the DMIC 104 via line 140 (e.g., via transmitting a disable bit or disable signal). Smart microphone 102 is the slave and AP 106 is the master as for communications between these components. The internal clock 172 of the AP 106 is used by the smart microphone 102. WS 136 of the AP 106 is synchronized with internal clock 172 of AP 106. Bi-directional exchange of I2S data (between smart microphone 102 and AP 106) is possible by disabling the PDM interface (disabling codec 108 and DMIC 104).

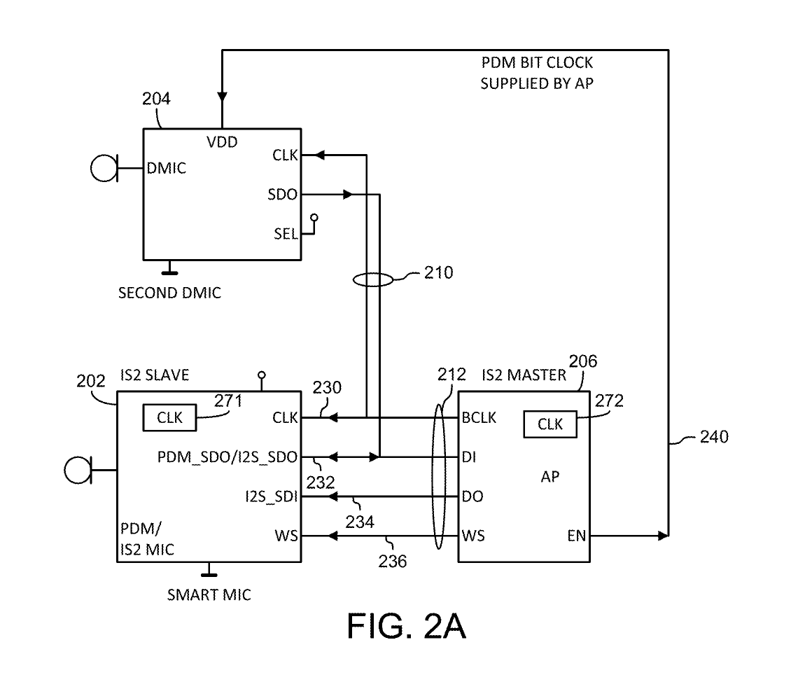

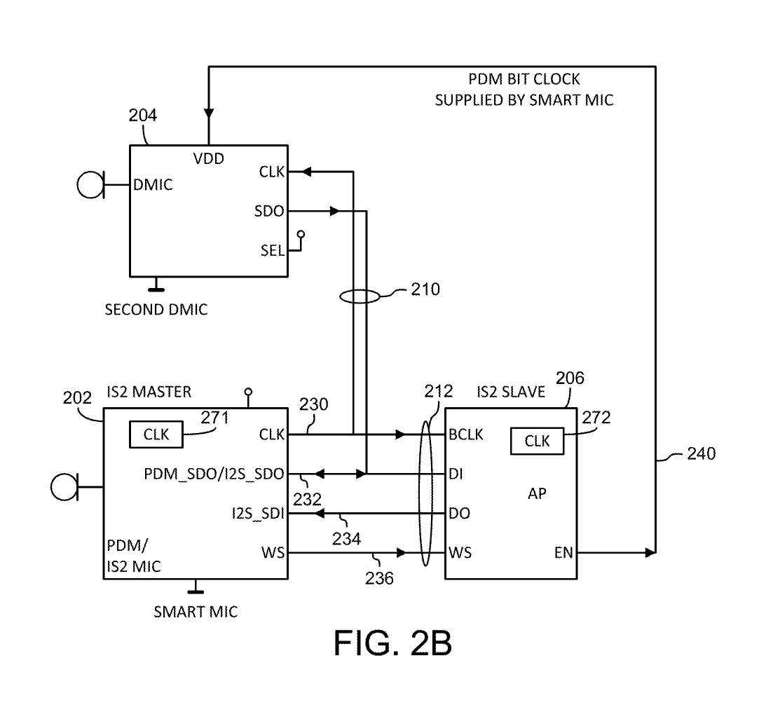

Referring now to FIG. 2A and FIG. 2B, another example of a system 200 using shared clocks is described. The system 200 is similar to that of FIG. 1, but omits the codec. The system 200 includes a smart microphone (Smart Mic) 202, a standard digital microphone (DMIC) 204, and an application processor (AP) 206. The structure of these components is the same as that described for like-numbered components of FIG. 1 and that description will not be repeated here.

A pulse density modulation (PDM) interface (or PDM-compliant interface) 210 couples DMIC 204, application processor 206, and Smart Mic 202. The PDM interface 210 includes a clock line 230 and a data line 232.

An I2S interface 212 couples the Smart Mic 202 and the application processor 206. The I2S interface includes the clock line 230 (which is shared with the PDM interface), the data line 232 (which is shared with the PDM interface), a data line 234, and word strobe (WS) line 236. The word strobe line 236 carries a pulsed signal (strobe) by which the data boundaries are marked.

The Smart Mic 202 has an internal clock 271. The AP 206 has an internal clock 272.

In one example of the operation of FIG. 2A, the AP 206 is the master and generates both the WS signal 236 and the clock signal 230 (from its internal clock 272). The smart microphone 202 is capable of simultaneous transmission of data over the I2S interface 212 to the AP 206 and reception of I2S data from the AP 206, when the standard digital microphone 204 is disabled via signal 240. The smart microphone 202 is capable of simultaneous reception of data over the PDM interface 210 from the DMIC 204 and reception of I2S data from the AP 206.

In one example of the operation of the system of FIG. 2B, the smart microphone 202 is the master and generates the WS signal 236 and the clock 230 (from its internal clock 271). The smart microphone 202 is capable of simultaneous reception of PDM data (from the standard digital microphone 204, over the PDM interface 210) and of I2S data (from the AP 206 via line 234). Bi-directional exchange of I2S data (between smart microphone 202 and AP 206) is also possible, when the standard digital microphone 204 is disabled via signal 240. By bi-directional, it is meant each device can transmit and receive data (i.e., a device is not limited to only receiving or only transmitting data).

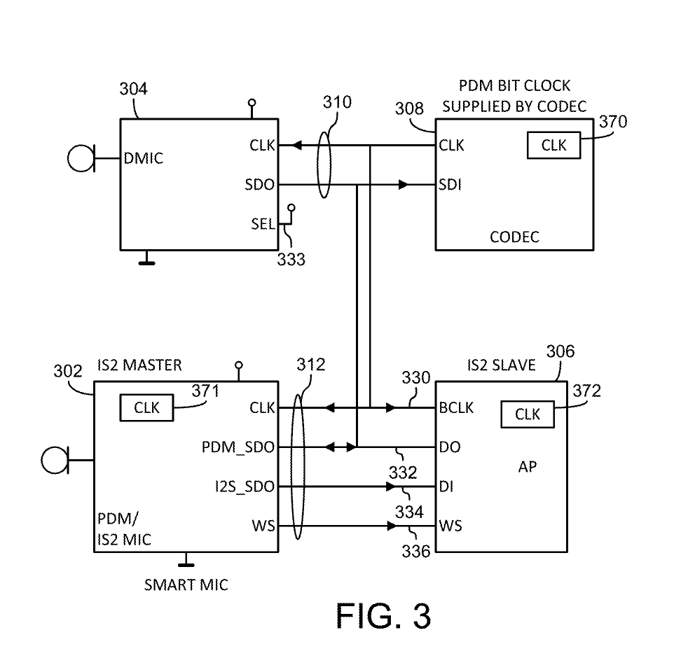

Referring now to FIG. 3, a system 300 includes a smart microphone (Smart Mic) 302, a standard digital microphone (DMIC) 304, an application processor (AP) 306, and a codec 308. The structure of these components is the same as that described for like-numbered components of FIG. 1 and that description will not be repeated here.

A pulse density modulation (PDM) interface (or PDM-compliant interface) 310 couples DMIC 304, codec 308, and Smart Mic 302. The PDM interface 310 includes a clock line 330 and a data line 332.

An I2S interface 312 couples the Smart Mic 302 and the application processor 306. The I2S interface includes the clock line 330 (which is shared with the PDM interface), a data line 334, and word strobe (WS) line 336. The word strobe line 336 is used to carry a pulsed signal (strobe) by which data boundaries are marked.

In summary, each of the four separate hardware components (Smart Mic 302, DMIC 304, AP 306, and codec 308) has pins that connect to the appropriate communication interface. For example, the DMIC 304 has a pin (CLK) connected to the clock line 330; a pin (SDO) connected to data line 332; and a pin (SEL) connected to the select input. The codec 308 has a pin (CLK) connected to the clock line 330; and a pin (SDO) connected to data line 332. The Smart Mic 302 has a pin (CLK) connected to the clock line 330; a pin (PDM_SDO) connected to data line 332; a pin I2S_SDI connected to data line 334; and a pin (WS) connected to the word strobe line 336. The AP 306 has a pin (BCLK) connected to the clock line 330; a pin (DI) connected to data line 334; a pin (DO) unconnected; and a pin (WS) connected to the word strobe line 336. As can been seen, the I2S interface 312 includes four pins while the PDM interface 310 requires three pins. No additional pins are required because the clock is shared between interfaces and between devices.

The codec 308 has an internal clock 370. The Smart Mic 302 has an internal clock 371. The AP 306 has an internal clock 372.

The system of FIG. 3 is similar to that of FIG. 1 except that data line 332 is not connected to the AP 306. In one example of the operation of the system of FIG. 3, no I2S data from the AP 306 can be sent to the smart microphone 302. Additionally, the AP 302 does not have to enable the codec 308. The clock 330 is sent from codec 308 (its internal clock 370) to the smart microphone 302.

The smart microphone 302 and the standard digital microphone 304 convert sound energy into digital signals. One of them sends out data to the codec 308 on the rising edge of the codec clock 330 and the other on the falling edge of the codec clock 330. A select line 333 may be used to program the DMIC 304 to transmit on a particular clock edge while the Smart Mic 302 can be factory pre-programmed to transmit on the other edge.

The smart microphone 302 is the master, but does not send out a clock signal. The clock signal from the codec 308 (from its internal clock 370) goes untouched and unaltered to the AP 306. The smart microphone 302 synchronizes its word strobe (WS) signal 336 with the codec clock 330. In these regards, it may count clock pulses of the codec clock 330 up to a number (e.g., 32) and then toggle WS 336 and continuously repeat this process.

Using these approaches, simultaneous transmission from the smart microphone 302 of PDM data (to the codec 308) and I2S data (to the AP 306) is possible. Simultaneous reception of PDM data at the Smart Mic 302 (from the standard digital microphone 304) is also possible. There is no reception of I2S data at the Smart Mic 302 from the AP 306.

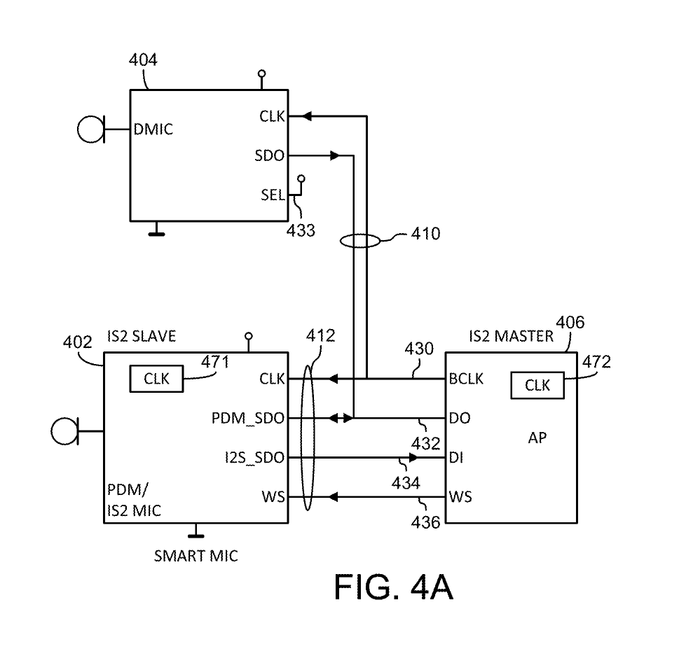

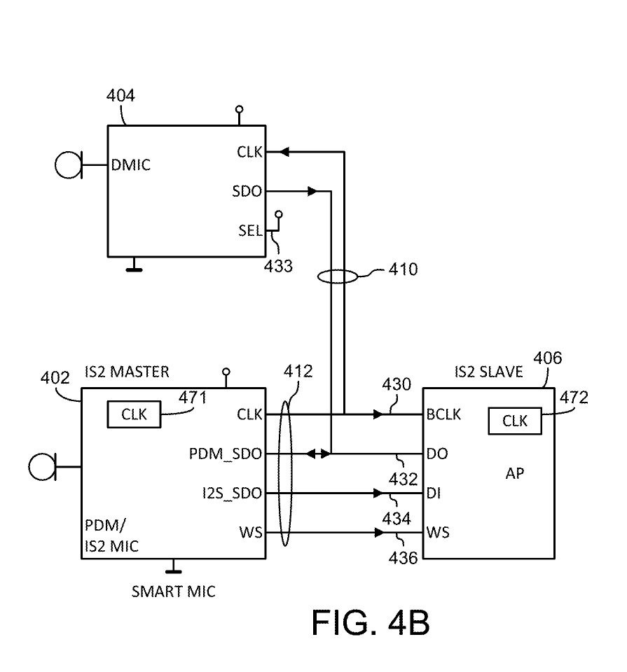

Referring now to FIG. 4A and FIG. 4B, another example of a system 400 is described. The system 400 is similar to that of FIG. 3, but omits the codec. The system 400 includes a smart microphone (Smart Mic) 402, a standard digital microphone (DMIC) 404, and an application processor (AP) 406. The structure of these components is the same as that described for like-numbered components of FIG. 3 and that description will not be repeated here.

A pulse density modulation (PDM) interface (or PDM-compliant interface) 410 couples DMIC 404, application processor 406, and Smart Mic 402. The PDM interface 410 includes a clock line 430 and a data line 432.

An I2S interface 412 couples the Smart Mic 402 and the application processor 406. The I2S interface includes the clock line 430 (which is shared with the PDM interface), the data line 432 (which is shared with the PDM interface), a data line 434, and word strobe (WS) line 436. The word strobe line 436 carries a pulsed signal (strobe) by which data is clocked. Data line 432 is not connected to the AP 406.

The Smart Mic 402 has an internal clock 471. The AP 406 has an internal clock 472.

In one example of the operation of the system of FIG. 4A, the AP 406 is the master and generates the WS signal 436 and the clock signal 430 (from clock 472) for use by the Smart Mic 402. Simultaneous reception at the smart microphone 402 of PDM data (from DMIC 404), and transmission of I2S data (to the AP 406) is possible. There is no reception of I2S data by the Smart Mic 402 from the AP 406.

In one example of the operation of the system of FIG. 4B, the smart microphone 402 is the master and generates the WS signal 436 and the clock signal 430 (from internal clock 471) for use by the AP 406. Simultaneous reception at the smart microphone 402 of PDM data (from DMIC 404) and I2S data (to the AP 406) is possible. There is no reception of I2S data from the AP 406.

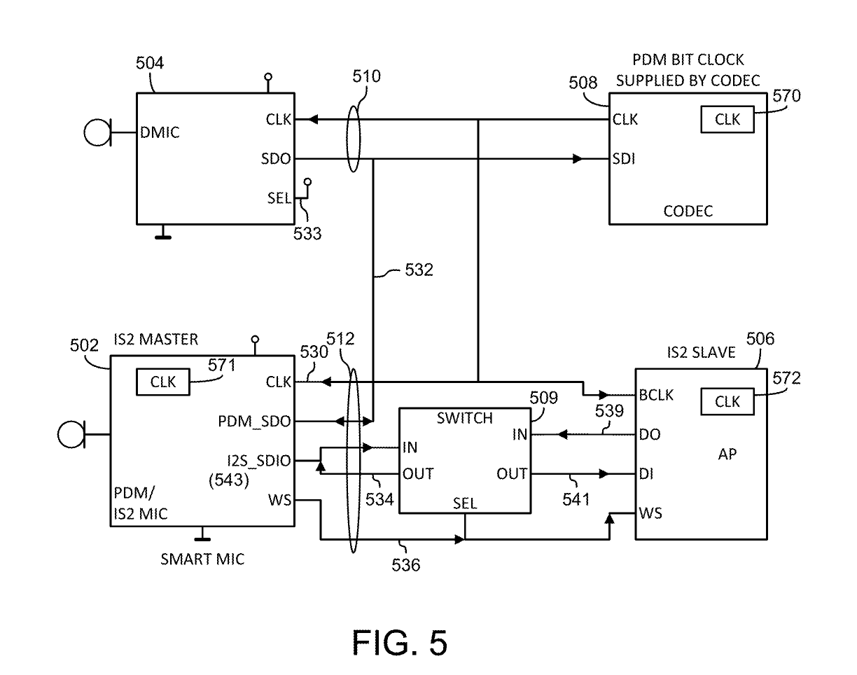

Referring now to FIG. 5, a system 500 includes a smart microphone (Smart Mic) 502, a standard digital microphone (DMIC) 504, an application processor (AP) 506, a codec 508, and glue logic 509. The structure of these components is the same as that described for like-numbered components of FIG. 1 and this description will not be repeated here.

FIG. 1 does not include glue logic 509, and in one example the glue logic 509 may be a switch that controls the direction of transmission of information. In one example, the glue logic 509 causes data to flow from the Smart Mic 502 to the AP 506. In another example, the glue logic 509 causes data to flow from the AP 506 to the Smart Mic 502.

A pulse density modulation (PDM) interface (or PDM-compliant interface) 510 couples DMIC 504, codec 508, application processor 506, and Smart Mic 502. The PDM interface 510 includes a clock line 530 and a data line 532.

An I2S interface 512 couples the Smart Mic 502 and the application processor 506. The I2S interface includes the clock line 530 (which is shared with the PDM interface), a data line 534, and word strobe (WS) line 536. The word strobe line 536 carries a pulsed signal (strobe) by which data boundaries are marked. WS line 536 also controls glue logic (multiplexer) 509 (when WS 536 is a 1, data flows one way; when WS is 0, data flows the other way). The PDM data line 532 is not connected to the AP 506. A data output 539 of AP 506 and Data input 541 of AP 506 are connected to glue logic 509. Data pin 543 of Smart Mic 502 (which can be either an input pin or output pin) is also connected to the glue logic 509 by line 534.

In summary, each of four separate hardware components (Smart Mic 502, DMIC 504, AP 506, and codec 508) has pins that connect to the appropriate communication line. For example, the DMIC 504 has a pin (CLK) connected to the clock line 530; a pin (SDO) connected to data line 532; and a pin (SEL) connected to the select input. The codec 508 has a pin (CLK) connected to the clock line 530; and a pin (SDI) connected to data line 532. The Smart Mic 502 has a pin (CLK) connected to the clock line 530; a pin (PDM_SDO) connected to data line 532; the pin 543 (I2S_SDIO) connected to glue logic 509; and a pin (WS) connected to the word strobe line 536. The AP 506 has a pin (BCLK) connected to the clock line 530; the pin 539 (DO) and the pin 541 (DI) are connected to glue logic 509; and a pin (WS) connected to the word strobe line 536. As can been seen, the I2S interface 512 includes four pins while the PDM interface 510 requires three pins. No additional pins are required because the clock is shared between interfaces and between devices.

The codec 508 has an internal clock 570. The Smart Mic 502 has an internal clock 571. The AP 506 has an internal clock 572.

In one example of the operation of the system of FIG. 5, the AP 506 does not have to disable the codec 508. The internal clock 570 (of the codec 506) is sent from codec 508 to the smart microphone 502 via line 530.

The smart microphone 502 and the standard digital microphone 504 convert sound energy into digital signals. One of them sends out data to the codec on the rising edge of the codec clock 530 and the other on the falling edge of the codec clock 570 transmitted on line 530.

The smart microphone 502 is the master (as between the smart microphone 502 and the AP 506), but does not send out its internal clock signal. The clock signal 530 (from internal clock 570) from the codec 508 goes untouched and unaltered to the AP 506. The smart microphone 502 synchronizes its word strobe (WS) signal 536 with the codec clock 570 as transmitted over line 530. In these regards, the smart microphone 502 may count clock pulses of the codec internal clock 570 (as transmitted over line 530) up to a number (e.g., 32) and then toggle WS and continue to repeat this process.

The glue logic 509 is in one aspect a switch allowing for bi-directional communication with the WS signal 536 controlling the multiplexer 509. In one WS state, data is transmitted from the AP 506 to the smart microphone 502. In other WS state, data is transmitted from the smart microphone 502 to the AP 506.

The smart microphone switches the I2S_SDIO pin 543 from being an input to being an output synchronized to the WS signal 536 and based upon a predetermined protocol. Simultaneous transmission of PDM data from the smart microphone 502 to the codec 508, and bi-directional communication of I2S data between the smart microphone 502 and the AP 506 is provided. Simultaneous reception of PDM data from the DMIC 504 at the Smart Mic 502, and bi-directional communication of I2S data between the smart microphone 502 and the AP 506 is also provided.

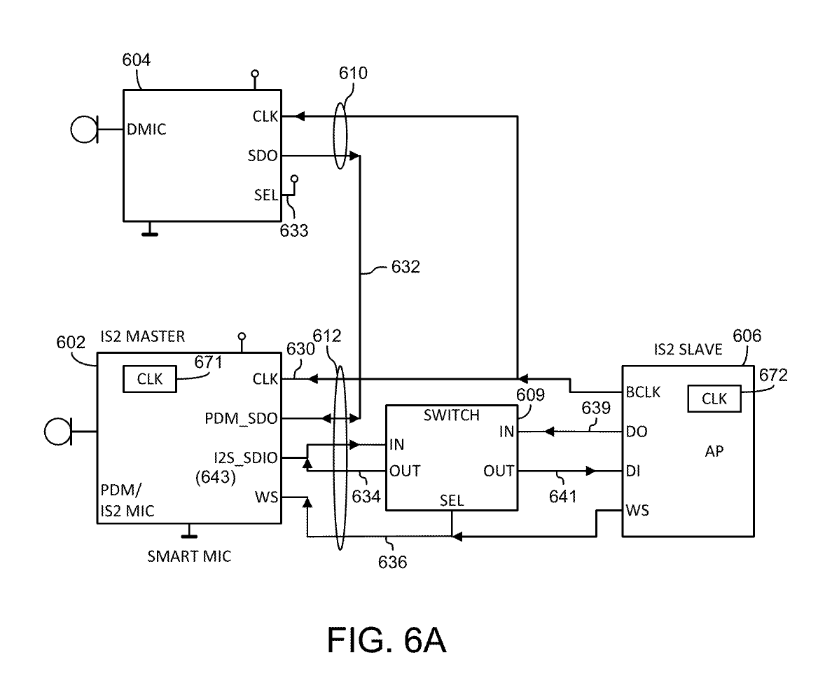

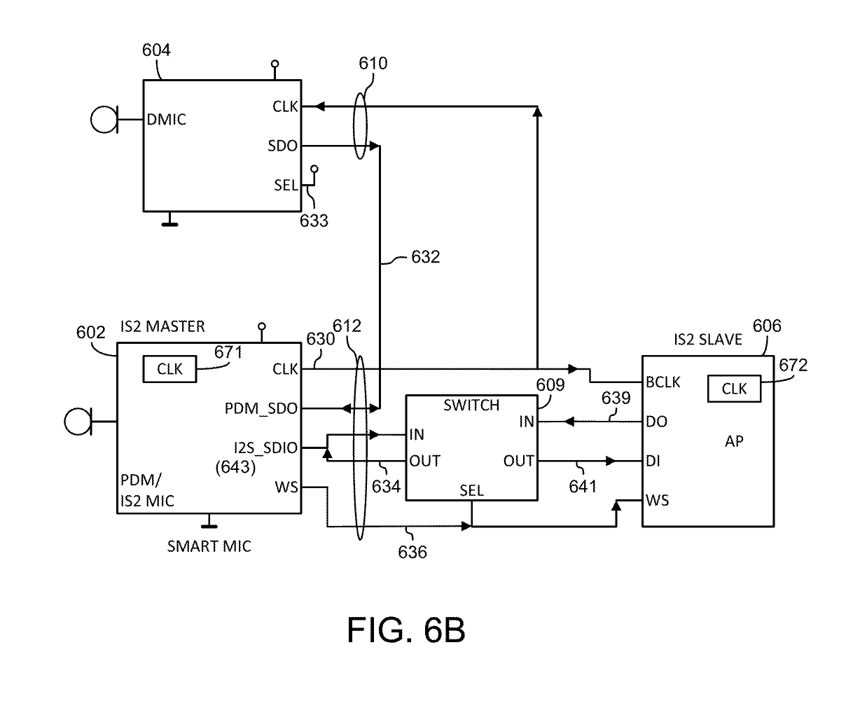

Referring now to FIG. 6A and FIG. 6B, another example of a system 600 is described. The system 600 is similar to that of FIG. 5, but omits the codec. The system 600 includes a smart microphone (Smart Mic) 602, a standard digital microphone (DMIC) 604, an application processor (AP) 606, and glue logic 609. The structure of these components is the same as that described for like-numbered components of FIG. 5 and this description will not be repeated here.

A pulse density modulation (PDM) interface (or PDM-compliant interface) 610 couples DMIC 604 and Smart Mic 602. The PDM interface 610 includes a clock line 630 and a data line 632.

An I2S interface 612 couples the Smart Mic 602 and the application processor 606. The I2S interface includes the clock line 630 (which is shared with the PDM interface), a data line 634, and word strobe (WS) line 636. The word strobe line 636 carries a pulsed signal (strobe) by which data is clocked. WS line 636 also controls glue logic (switch) 609 (when WS 636 is a 1, data flows one way; when WS is 0, data flows the other way). Data line 632 is not connected to the AP 606. A data output 639 of AP 606 and Data input 641 of AP 606 are connected to glue logic 609. Data pin 643 of Smart Mic 602 (which can be either an input pin or output pin) is also connected to the glue logic 609.

The Smart Mic 602 has an internal clock 671. The AP 606 has an internal clock 672.

In one example of the operation of the system of FIG. 6A, the AP 606 is the master and generates the WS signal 636 and the clock signal 630 (from the internal clock 672 of the AP 606). Simultaneous reception of PDM data (at the Smart Mic 602 from the DMIC 604) and bi-directional communication of I2S data between the smart microphone 602 and the AP 606 is also provided.

In one example of the operation of the system of FIG. 6B, the smart microphone 602 is the master and generates the WS signal 636 and the clock signal 630 (from the internal clock 671 of the Smart Mic 602). Simultaneous reception of PDM data (at the Smart Mic 602 from the DMIC 604) and bi-directional communication of I2S data between the smart microphone 602 and the AP 606 is provided.

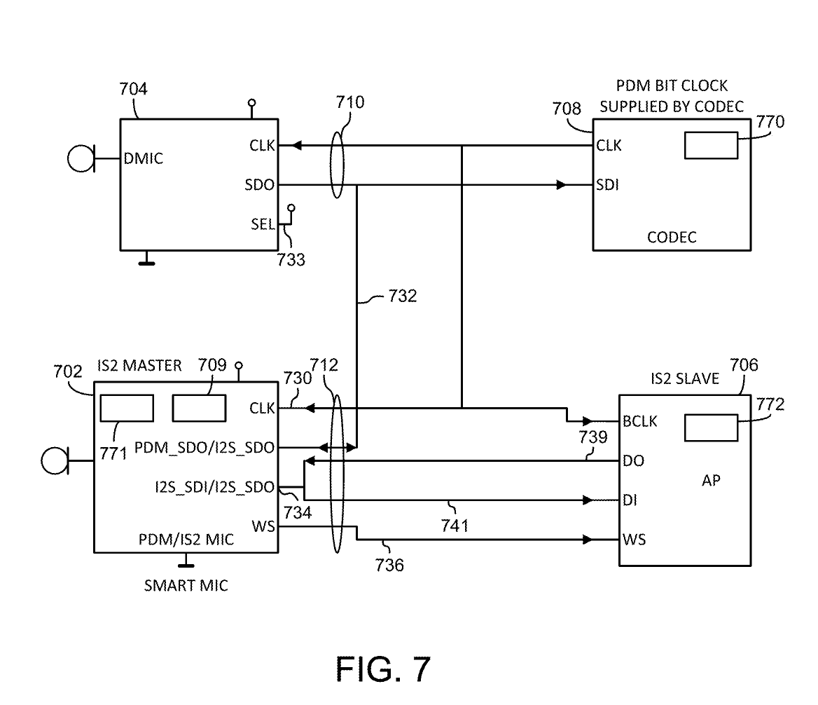

Referring now to FIG. 7, a system 700 includes a smart microphone (Smart Mic) 702, a standard digital microphone (DMIC) 704, an application processor (AP) 706, a codec 708, and glue logic 709 in the SmartMic 702 (e.g., within the outer housing of the SmartMic 702). The structure of these components is the same as that described for like-numbered components of FIG. 5 and this description will not be repeated here.

In one example the glue logic 709 may be a switch that controls the direction of transmission of information. In one example, the glue logic 709 causes data to flow from the Smart Mic 702 to the AP 706. In another example, the glue logic 709 causes data to flow from the AP 706 to the Smart Mic 702.

A pulse density modulation (PDM) interface (or PDM-compliant interface) 710 couples DMIC 704, codec 708, application processor 706, and Smart Mic 702. The PDM interface 710 includes a clock line 730 and a data line 732.

An I2S interface 712 couples the Smart Mic 702 and the application processor 706. The I2S interface includes the clock line 730 (which is shared with the PDM interface), a data line 734, and word strobe (WS) line 736. The word strobe line 736 carries a pulsed signal (strobe) by which data boundaries are marked. WS line 736 also controls glue logic (multiplexer) 709 (when WS 736 is a 1, data flows one way; when WS is 0, data flows the other way). The PDM data line 732 is not connected to the AP 706. A data output 739 of AP 706 and Data input 741 of AP 706 are connected to glue logic 709 by line 734. Data pin 743 of Smart Mic 702 (which can be either an input pin or output pin) is also connected to the glue logic 709 by line 734.

In summary, each of four separate hardware components (Smart Mic 702, DMIC 704, AP 706, and codec 708) has pins that connect to the appropriate communication line. For example, the DMIC 704 has a pin (CLK) connected to the clock line 730; a pin (SDO) connected to data line 732; and a pin (SEL) connected to the select input. The codec 708 has a pin (CLK) connected to the clock line 730; and a pin (SDI) connected to data line 732. The Smart Mic 702 has a pin (CLK) connected to the clock line 730; a pin (PDM_SDO) connected to data line 732; the pin 743 (I2S_SDIO) connected to glue logic 709 (in the SmartMic 702); and a pin (WS) connected to the word strobe line 736. The AP 706 has a pin (BCLK) connected to the clock line 730; the pin 739 (DO) and the pin 741 (DI) are connected to the SmartMic 702 at pin 743; and a pin (WS) connected to the word strobe line 736. As can been seen, the I2S interface 712 includes four pins while the PDM interface 710 requires three pins. No additional pins are required because the clock is shared between interfaces and between devices.

The codec 708 has an internal clock 770. The Smart Mic 702 has an internal clock 771. The AP 706 has an internal clock 772. The operation of the system of FIG. 7 and the glue logic 709 is similar to that of the system of FIG. 5 with the exception that the glue logic is disposed in the SmartMic 709. It will also be appreciated that the glue logic may also be disposed in others of the elements of the system of FIG. 7.

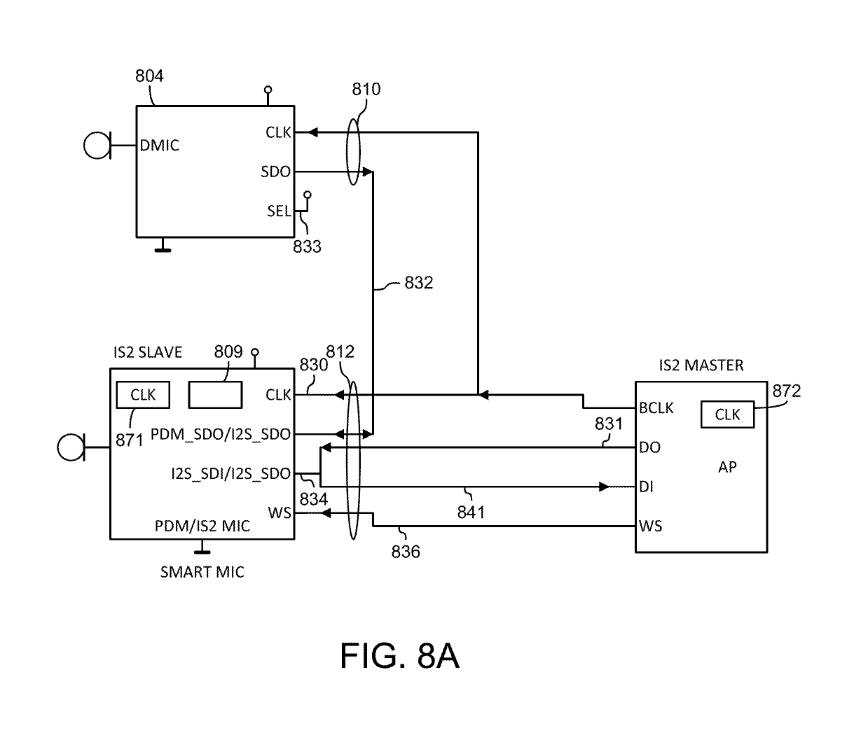

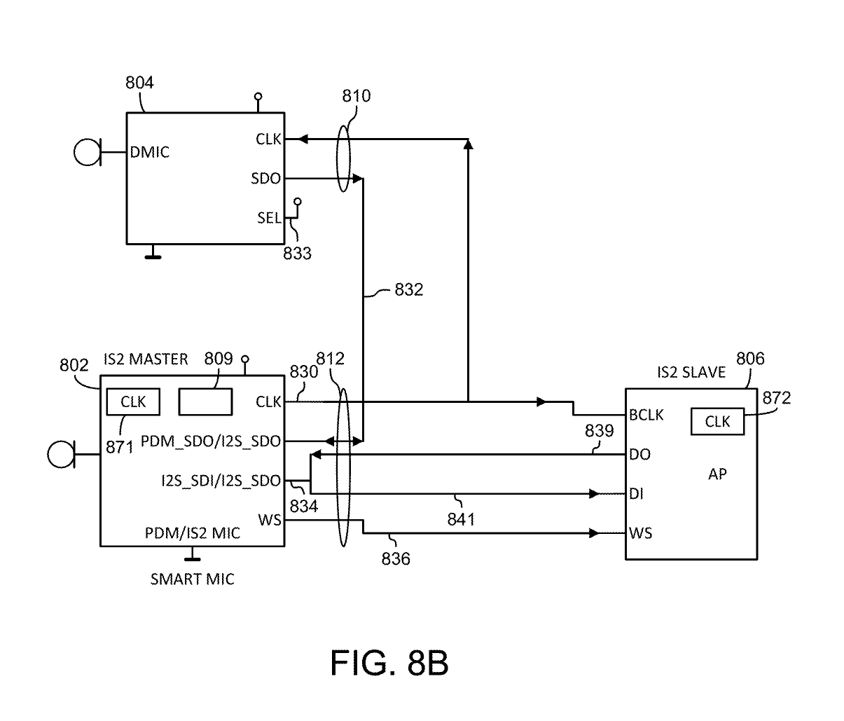

Referring now to FIG. 8A and FIG. 8B, another example of a system 800 is described. The system 800 is similar to that of FIG. 7, but omits the codec. The system 800 includes a smart microphone (Smart Mic) 802, a standard digital microphone (DMIC) 804, an application processor (AP) 806, and glue logic 809. The structure of these components is the same as that described for like-numbered components of FIG. 7 and this description will not be repeated here.

A pulse density modulation (PDM) interface (or PDM-compliant interface) 810 couples DMIC 804 and Smart Mic 802. The PDM interface 810 includes a clock line 830 and a data line 832.

An I2S interface 812 couples the Smart Mic 802 and the application processor 806. The I2S interface includes the clock line 830 (which is shared with the PDM interface), a data line 834, and word strobe (WS) line 836. The word strobe line 836 carries a pulsed signal (strobe) by which data is clocked. WS line 836 also controls glue logic (switch) 809 (when WS 836 is a 1, data flows one way; when WS is 0, data flows the other way). Data line 832 is not connected to the AP 806. A data output 839 of AP 806 and Data input 841 of AP 806 are connected to pins on the Smart Mic 802 (and thence to glue logic 809). Data pin 834 of Smart Mic 802 (which can be either an input pin or output pin) is connected to the AP 806.

The Smart Mic 802 has an internal clock 871. The AP 806 has an internal clock 872. The operation of the systems of FIGS. 8A and 8B and the glue logic 809 is similar to that of the systems of FIGS. 6A and 6B respectively with the exception that the glue logic is disposed in the SmartMics 809. It will also be appreciated that the glue logic may also be disposed in others of the elements of the systems of FIGS. 8A and 8B.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An acoustic apparatus comprising:
a first digital microphone having a first clock pin;
a second digital microphone having a second clock pin;
an application processor having a third clock pin;
a first interface that couples the first microphone and the application processor;
a second interface that couples the first digital microphone, the second digital microphone, and the application processor; and
a clock that connects to the first clock pin, the second clock pin, and the third clock pin, wherein first data is transmitted on a first clock edge, and wherein second, different data is transmitted on a second other clock edge.

2. The acoustic apparatus of claim 1, wherein the first interface is an integrated interchip sound (I2S) interface.

3. The acoustic apparatus of claim 1, wherein the second interface is a pulse density modulation (PDM) interface.

4. The acoustic apparatus of claim 1, wherein the first data is data from the first digital microphone, and wherein the second data is data from the second digital microphone.

5. The acoustic apparatus of claim 1, wherein the first digital microphone is configured to simultaneous transmit data over the first interface to the application processor and receive data from the application processor.

6. The acoustic apparatus of claim 1, wherein the first digital microphone is configured to simultaneous receive data over the second interface from the second digital microphone and receive data from the application processor.

7. The acoustic apparatus of claim 1, wherein the first digital microphone comprises the clock.

8. The acoustic apparatus of claim 1, wherein the application processor comprises the clock.

9. The acoustic apparatus of claim 1, further comprising a codec having a fourth clock pin, wherein the clock connects to the fourth clock pin.

10. The acoustic apparatus of claim 9, wherein the codec comprises the clock.

11. The acoustic apparatus of claim 9, wherein the application processor is configured to enable the codec, and wherein the first digital microphone is configured to synchronize a word strobe signal with the clock of the codec.

12. The acoustic apparatus of claim 9, further comprising glue logic configured to:
receive a select signal;
receive data from the first digital microphone;
receive data from the application processor;
send data from the first digital microphone to the application processor when the select signal is a first value; and
send data from the application processor to the first digital microphone when the select signal is a second value.

13. The acoustic apparatus of claim 12, wherein the first digital microphone comprises the glue logic.

14. A system comprising:
a first digital microphone having a first clock pin;
a second digital microphone having a second clock pin;
an application processor having a third clock pin;
a first interface that couples the first microphone and the application processor;
a second interface that couples the first digital microphone, the second digital microphone, and the application processor; and
a clock that connects to the first clock pin, the second clock pin, and the third clock pin, wherein first data is transmitted on a first clock edge, and wherein second, different data is transmitted on a second other clock edge.

15. The system of claim 14, wherein the first interface is an integrated interchip sound (I2S) interface.

16. The system of claim 14, wherein the second interface is a pulse density modulation (PDM) interface.

17. The system of claim 14, wherein the first data is data from the first digital microphone, and wherein the second data is data from the second digital microphone.

18. The system of claim 14, wherein the first digital microphone is configured to simultaneous transmit data over the first interface to the application processor and receive data from the application processor.

19. The system of claim 14, wherein the first digital microphone is configured to simultaneous receive data over the second interface from the second digital microphone and receive data from the application processor.

20. The system of claim 14, wherein the first digital microphone comprises the clock.
